(19) United States
(12) Patent Application Publication
(10) Pub. No.: US 2016/0356269 A1
(43) Pub. Date: Dec. 8, 2016

(54) PUMPING DEVICE WITH DIRECT DRIVE

(71) Applicant: Dresser, Inc., Addison, TX (US)

(72) Inventors: Francisco Manuel Gutierrez, League City, TX (US); Robert Erling Fowler, Houston, TX (US)

(21) Appl. No.: 14/732,731

(22) Filed: Jun. 7, 2015

(51) Int. Cl. F04B 49/20; F04B 19/22; G05B 19/4155; F04B 39/12; F04B 53/16; F04B 53/14; F04B 17/03; F04B 35/04

(52) U.S. Cl. CPC F04B 49/20; F04B 17/03; F04B 19/22; F04B 35/04; F04B 39/12; F04B 53/16; F04B 53/14; G05B 19/4155; G05B 2219/43193

(57) ABSTRACT

A pumping device configured to directly drive a reciprocating member to pump a fluid. In one embodiment, the pumping device comprises a body forming an internal chamber. The reciprocating member may be disposed in the body, the reciprocating member having a first end, a second end, and an axis. The embodiment may further include a drive system magnetically coupled with the reciprocating member, the drive system comprising a first conductive body affixed relative to the reciprocating member. The drive system may be configured to induce a first magnetic field by energizing the first conductive body. The reciprocating member may be configured to induce a second magnetic field in a manner that causes the reciprocating member to move between a first position and a second position to fill and evacuate the internal chamber with a fluid.

### BACKGROUND

Pumps are useful to move fluids (e.g., liquids and gasses) with mechanical action. Reciprocating or positive displacement pumps may be configured to capture a fixed amount of fluid from an inlet and to force the captured amount of fluid to an outlet (or discharge). This configuration may result in flow rates that are constant because, theoretically, these pumps may produce the same flow rate at a given speed independent of the discharge pressure.

### SUMMARY

This disclosure relates generally to pumps, with particular discussion about a system to directly drive a reciprocating member in a positive displacement pump.

Some embodiments disclosed herein may directly drive a reciprocating member to capture and discharge fluid in a positive displacement pump and/or a pumping device in general. This direct drive may include a magnetic drive system with one or more conductive members, e.g., coils and/or wound wire. The direct drive may energize the conductive members to generate a magnetic field. By modulating the polarity of the conductive members, the direct drive system may effectuate “pumping action” or reciprocating motion without the need for mechanical components and/or coupling mechanisms that might introduce losses and complicate the assembly of the pumping device.

Certain embodiments address problems with construction of positive displacement pumps. In one example, the pump may include a rotary input, such as a motor with a rotating output shaft. The pump may also include a converter system to convert the rotation of the output shaft into an axially reciprocating motion. The converter system may be mechanical, e.g., a crankshaft, a cam system, a rack and pinion system, or like combination of mechanical components. To drive the plunger to capture and discharge fluid, the pump may also include a cross-head housing that couples the converter system to the plunger. However, use of the cross-head housing often positions the axis of the plunger at a right angle relative to the axis of the motor shaft. The use of the converter and housing increases the complexity and material costs of the pump. The addition of mechanical components may also introduce additive mechanical losses, typically at the interface and/or coupling between, for example, the converter system and the cross-head housing and the cross-head housing and the plunger. Over time, such mechanical losses may decrease pump efficiency, introduce error or uncertainty in flow rate calculation, and reduce life cycle of the pump.

In light of the foregoing, the embodiments herein may incorporate elements and features, one or more of the elements and features being interchangeable and/or combinable in various combinations, examples of which may include:

A pumping device that may include a body forming an internal chamber, a reciprocating member disposed in the body, the reciprocating member having a first end, a second end, and an axis, and a drive system magnetically coupled with the reciprocating member, the drive system including a first conductive body affixed relative to the reciprocating member. The drive system may be configured to induce a first magnetic field by energizing the first conductive body, and the reciprocating member may be configured to induce a second magnetic field in a manner that causes the reciprocating member to move between a first position and a second position to fill and evacuate the internal chamber with a fluid.

The pumping device in which the drive system includes a second conductive body and the second magnetic field results from energizing the second conductive body.

The pumping device in which the second conductive body is affixed to the reciprocating member.

The pumping device in which the first conductive body is disposed coaxially with the axis of the reciprocating member and the reciprocating member is configured to translate through the first conductive body between the first position and the second position.

The pumping device may further include a plurality of shaft members coupled to the reciprocating member and spaced apart from one another along the axis and the shaft members are configured to generate the second magnetic field at a value and a direction that are constant.

The pumping device in which the first magnetic field corresponds with a first pattern and a second pattern of voltage polarities that energize the first conductive body and the first pattern and the second pattern are configured so that the reciprocating member moves from the first position to the second position in response to the first pattern and from the second position to the first position in response to the second pattern.

The pumping device in which the drive system includes a magnet disposed on the first end of the reciprocating member and the magnet generates the second magnetic field at a value and a direction that are constant.

The pumping device may further include a control system that may include a sensor system proximate the reciprocating member, and a controller coupled with the sensor system. The controller may be configured to modulate the first magnetic field and the second magnetic field in response to a signal from the sensor system that corresponds with one of the first position and the second position of the reciprocating member.

The pumping device in which the sensor system includes a pair of sensors in position relative to the reciprocating member and the pair of sensors are configured to generate a first signal and a second signal, one each that indicates the first position and the second position.

The pumping device in which the controller has a processor with access to executable instructions and the processor is configured to execute the executable instruction to configure the controller to receive the signal from the sensor system, the signal corresponding with a measured position for the reciprocating member in the body, compare the measured position to one or more position thresholds for the reciprocating member, determine a direction of travel for the reciprocating member in accordance with a relationship between the measured position and the one or more position thresholds, and regulate an electrical signal to induce one or more of the first magnetic field and the second magnetic field corresponding with the direction of travel for the reciprocating member.

A pumping device may include a body including a first inlet/outlet, a second inlet/outlet, and an internal chamber in flow communication with each of the first inlet/outlet and the second inlet/outlet, the body having a first bore coupled with the internal chamber, a reciprocating member disposed in the first bore, the reciprocating member having a first end, a second end, and an axis, a first coil affixed in the body, the first coil including a first set of windings that circumscribe the axis of the reciprocating member. The first set of windings may be configured to generate a first magnetic field in response to an electrical signal. The reciprocating member may be configured to generate a second magnetic field to move the reciprocating member between a first position and a second position in the first bore in response to an interaction with the first magnetic field.

The pumping device may further include a magnet coupled to the reciprocating member and the magnet generates the second magnetic field at a constant value and in a constant direction.

The pumping device in which the reciprocating member is configured to move at least partially through the first set of windings.

The pumping device may further include a second coil spaced apart from the first coil along the axis, the second coil including a second set of windings that are configured to generate the second magnetic field.

The pumping device in which the second set of windings is affixed to the reciprocating member.

The pumping device may further include a first sensor in proximity to the reciprocating member and a controller coupled with the first sensor, the controller configured to modulate an electrical signal to induce at least one of the first magnetic field and the second magnetic field.

The pumping device in which the controller has a processor with access to executable instructions and the processor is configured to execute the executable instruction to configure the controller to receive a signal from the first sensor, the signal corresponding with a measured position for a reciprocating member in the pumping device, compare the measured position to one or more position thresholds for the reciprocating member, determine a direction of travel for the reciprocating member in accordance with a relationship between the measured position and the one or more position thresholds, and regulate the electrical signal to induce one or more of the first magnetic field and the second magnetic field corresponding with the direction of travel for the reciprocating member.

A method of operating a pumping device may include receiving a signal corresponding with a measured position for a reciprocating member in the pumping device, comparing the measured position to one or more position thresholds for the reciprocating member, determining a direction of travel for the reciprocating member in accordance with a relationship between the measured position and the one or more position thresholds, regulating an electrical signal to induce one or more magnetic fields corresponding with the direction of travel for the reciprocating member.

The method may further include coupling the electrical signal to a first coil magnetically coupled with the reciprocating member, wherein the first coil is configured to generate a first magnetic field that corresponds with the direction of travel for the reciprocating member.

The method may further include coupling the electrical signal to a second coil that is spaced part from and magnetically coupled with the first coil, wherein the second coil is configured to generate a second magnetic field that corresponds with the direction of travel for the reciprocating member.

A pumping device may include a body forming an internal chamber, a reciprocating member disposed in the body, the reciprocating member having a first end, a second end, and an axis; and a drive system magnetically coupled with the reciprocating member, the drive system including a first conductive member and a second conductive member affixed relative to the reciprocating member, wherein the drive system is configured to induce a first magnetic field by energizing the first conductive member, and wherein the reciprocating member includes a disk member disposed on the first end and interposed between the first magnetic field and the second magnetic field, and wherein the drive system is configured to alternately energize the first conductive member and the second conductive member to effectuate movement of the disk member and the reciprocating member between a first position and a second position to fill and evacuate the internal chamber with fluid.

### BRIEF DESCRIPTION OF THE DRAWINGS

Reference is now made briefly to the accompanying drawings, in which:

FIG. 1 depicts schematic, block diagram of a pumping device;

FIG. 2 depicts a schematic diagram of a plan view for a first configuration of a drive system for use in the pumping device of FIG. 1;

FIG. 3 depicts a schematic diagram of a plan view for a second configuration of a drive system for use in the pumping device of FIG. 1;

FIG. 4 depicts a schematic diagram of a plan view for a third configuration of a drive system for use in the pumping device of FIG. 1;

FIG. 5 depicts a schematic diagram of a plan view for a fourth configuration of a drive system for use in the pumping device of FIG. 1;

FIG. 6 depicts a plan view of the cross-section of an example of the pumping device of FIG.1; and

FIG. 7 depicts a flow diagram of a method for operating a pumping device using a direct drive system.

Where applicable like reference characters designate identical or corresponding components and units throughout the several views, which are not to scale unless otherwise indicated. The embodiments disclosed herein may include elements that appear in one or more of the several views or in combinations of the several views. Moreover, methods are exemplary only and may be modified by, for example, reordering, adding, removing, and/or altering the individual stages.

### DETAILED DESCRIPTION

The discussion below describes various embodiments of a pumping device. These embodiments may include a direct drive (also, “drive system”) that uses magnetism to reciprocate a plunger. The drive system forgoes the need for mechanical couplings to transfer motion from, e.g., a motor to the plunger. In this way, the embodiments may eliminate mechanical losses that might frustrate operation and/or reduce service life of the pumping device. Other embodiments are within the scope of the disclosed subject matter.

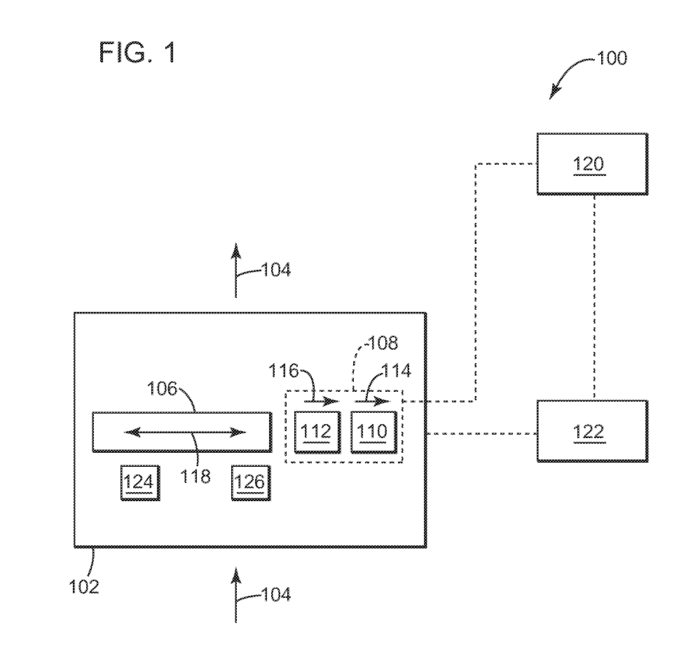

FIG. 1 illustrates a schematic block diagram of an exemplary embodiment of a pumping device 100. This embodiment may embody reciprocating pumps and positive displacement pumps, as well as other devices that operate on a fluid. The pumping device 100 may include a pump head 102 that may pump a volume of fluid 104. In one example, the pump head 102 may include a reciprocating member 106 (also, “plunger 106”) that translates in the pump head 102 to move the fluid 104. The plunger 106 may couple with a direct drive system 108 (also “drive system 108”). In one example, the drive system 108 may include a pair of field generators (e.g., a first field generator 110 and a second field generator 112). The field generators 110, 112 may be configured to generate a first magnetic field 114 and a second magnetic field 116, respectively. At least one of the magnetic fields 114, 116 may reside proximate the plunger 106 and, in one example, may couple with and/or or circumscribe the plunger 106, as show in the examples below. The configuration of the field generators 110, 112 may leverage magnetic interactions to “push” and/or “pull” the plunger 106 in the pump head 102. In turn, the plunger 106 may translate or “reciprocate,” as shown generally as the double arrow 118 in FIG. 1. The motion 118 may effectuate pumping action to fill and evacuate the volume of fluid 104 in the pump head 102.

Use of the field generators 110, 112 may eliminate mechanical couplings to translate the plunger 106. The field generators 110, 112 may include electromagnets, permanent magnets, and like devices that may generate the magnetic fields 114, 116. The discussion herein describes some of examples of the field generators 110, 112 that comprise wound and/or coiled wire with ends that may conduct an electrical signal. However, these embodiments are exemplary only, and the scope and spirit of this disclosure contemplates a wide variety of configurations for the field generators 110, 112.

As also shown in FIG. 1, the pumping device 100 may include a control system to govern operation of the drive system 108. This control system may couple with a power source 120 that is configured to provide the electrical signal (e.g., current, voltage, etc.) to energize the drive system 108. The control system may have a controller 122 that couples with one or more sensors (e.g., a first sensor 124 and a second sensor 126). The controller 122 may include one or more processors (e.g., ASIC) and/or one or more storage memory (e.g., RAM, ROM, etc.) that may store executable instructions in the form of computer programs (e.g., software, firmware, etc.) to be executed by the one or more processors. In use, the controller 122 may receive a signal from one or both of the sensors 124, 126 and generate commands using data from the signal. The commands may instruct operation of the drive system 108 to modify the movement of the plunger 106. This feature is useful to allow the pumping device 100 to precisely regulate the volume of fluid 104 over a specified time period to achieve a very accurate flow rate.

The pumping device 100 may include one or more switches (not shown) to regulate the electrical signal that energizes one or more of the field generators 110, 112. These switches may include relays that are interposed between the power source 120 and the field generators 110, 112, where applicable. The controller 122 may be configured to change the state of the switches, e.g., from an open state to a closed state. The states of the switches may complete an electrical circuit necessary to allow the electrical signal to flow through the field generators 110, 112. In one example, the magnetic fields 114, 116 may be sustained as long as the corresponding switch is in the closed position to complete the electrical circuit.

The controller 122 may use signals from the sensors 124, 126 to identify and regulate the axial position of the plunger 106. Data from the signals may indicate the plunger 106 is at or near a first position and/or a second position in the pump head 102. The controller 122 may generate one or more outputs in response to this data. The outputs may actuate the state of the switches (discussed above) and/or regulate properties (e.g., current, voltage, etc.) of the electrical signal that the power source 120 delivers to the field generators 110, 112. In one implementation, the controller 122 may operate to energize or de-energize the field generators 110, 112. Such operation may change the polarity of the field generators 110, 112 and, in turn, modify the direction of the magnetic fields 114, 116. The change in direction may move the plunger 106 as noted herein.

The controller 122 may also operate to change the magnitude of the electrical signal that the power source 120 delivers to the field generators 110, 112. The change in magnitude of the electrical signal may include step changes between different levels or values of magnitude of current and/or voltage, as well as ramp changes in which values of current and/or voltage modulate over time and/or in accordance with some defined parameters (e.g., a linear scale). In one example, the controller 122 may be configured to regulate the electrical signal from the power source 120 as one or more electrical pulses, wherein the pulses may have one or more operating parameters (e.g., frequency, duration, amplitude, etc.) that govern the speed at which the plunger 106 travels between the first position and the second position and the magnitude of the force to move the plunger 106.

The sensors 124, 126 may indicate the location of the plunger 106 in the pumping device 100. Examples of the sensors 124, 126 may include proximity sensors (e.g., eddy current sensors, optical sensors, ultrasonic sensors, Hall Effect sensors, a linear variable differential transformer (LVDT) etc.) and like sensing devices that generate a signal in response to the position of the plunger 106 relative to the sensing device. In some arrangements, the sensors 124, 126 do not physically contact the plunger 106. The sensors 124, 126 may instead couple close enough to acquire accurate readings that reflect the position of the plunger 106. In one implementation, LVDTs may provide a useful advantage over other types of position sensors. Using this type of device may, for example, require the pumping device 100 to include only one of the sensors 124, 126. In one example, LVDTs may convert position or linear displacement from a zero reference position into a proportional electrical signal containing information that defines phase (for direction) and amplitude (for distance). LVDTs do not require an electrical contact between the plunger 106 and the coil assembly on LVDTs, but instead rely on electromagnetic coupling. Use of the information for phase and amplitude may allow use of a user configurable variable to assign the stroke length of the plunger 106. In one implementation, an end user may input a stroke length (e.g., 15 mm, 20 mm, etc.) as a threshold or maximum value for the LVDT sensor. The controller 122 may be configured to reverse the motion of the plunger 106 in response to signals from the LVDT sensor that indicate that the plunger 106 has reached the threshold value.

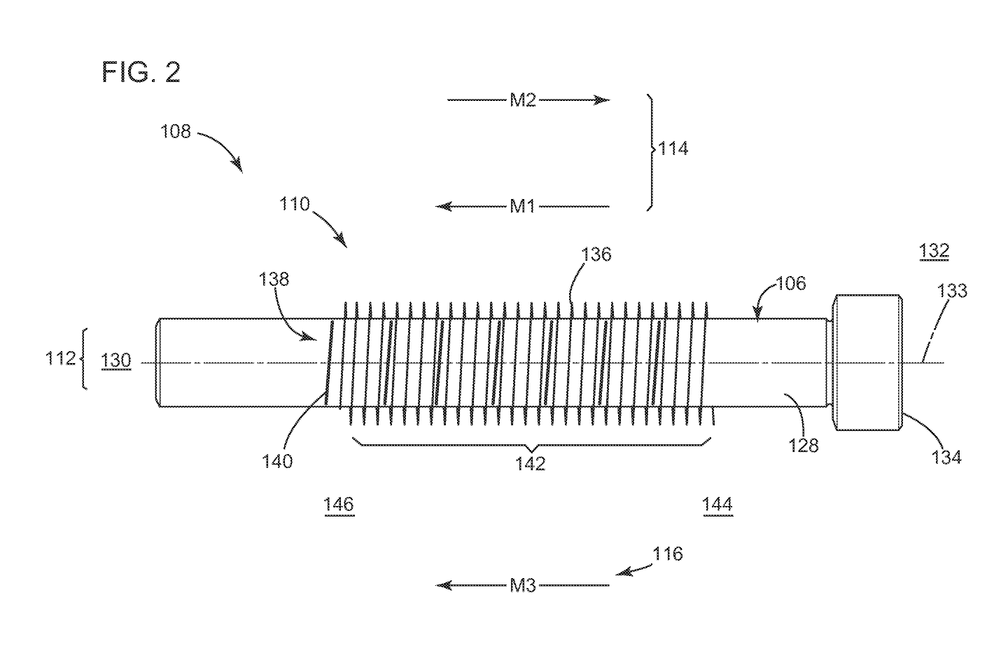

FIGS. 2, 3, and 4 depict examples of the drive system 108. The pumping device 100 (FIG. 1) may incorporate these examples to move the plunger 106 in different directions. Each of the examples defines a configuration for the field generators 110, 112 that generate the magnetic fields 114, 116 to initiate motion of the plunger 106. However, while any one of these configurations may find use as a single device, the parts of each configuration may be mixed and matched together to arrive at an appropriate configuration for the pumping device 100 to pump fluids as noted herein.

FIG. 2 depicts a schematic diagram of a plan view for a first configuration of the drive system 108. In this example, the plunger 106 has a shaft member 128 with a pair of ends (e.g., a first end 130 and a second end 132) and an axis 133. At the second end 132, the shaft member 128 may include a header member 134 to facilitate attachment to other pump members and/or provide one or more surfaces that afford bearing support, as necessary. The shaft member 128 may have an elongate body that may be cylindrical with an annular cross-section; however this disclosure does contemplate that the elongate body may assume other shapes and/or cross-sections (e.g., rectangular, square, octagon, etc.). For annular cross-sections, the elongate body may have a diameter in a range from approximately 4 mm to approximately 13 mm. Actual dimensions for the cross-section (and other properties of the shaft member 128) may vary based on, for example, operative parameters for the pumping device 100 (FIG. 1) including the flow rate of fluid 104 (FIG. 1) through the pump head 102 (FIG. 1).

Construction of the plunger 106 may use any material appropriate to the application of the pumping device 100 (FIG. 1). Exemplary materials may include metals (e.g., stainless steel), plastics, ceramic, and combinations and derivations thereof. The header element 134 may be formed integrally with the shaft member 128 as a monolithic unit and/or as one or more separate pieces that are fastened to the shaft member 128.

Also in FIG. 2, the first field generator 110 has a first conductive body 136 that is configured to generate the first magnetic field 114. The second field generator 112 may embody a material member 138 that is disposed on and/or integrated with the shaft member 128 of the plunger 106. The shaft member 128 may incorporate the material member 138, either as an integral part of the structure or as one or more individual magnetic pieces 140 that are dispersed and/or spaced axially apart from one another throughout the shaft member 128. The first conductive body 136 may embody a coil of wound, conductive wire (or like material) forming a first set of windings 142. The windings 142 may have a pair of terminal ends (e.g., a first terminal end 144 and a second terminal end 146). The windings 142 may be sized and configured to receive the shaft member 128. For example, the inner dimensions of the windings 142 and the outer dimensions of the shaft member 128 may be sized as a slip fit and/or an interference fit with loosely-toleranced dimensions. These dimensions may allow the shaft member 128 to extend at least partially into the windings 142 and/or to translate into and through the windings 142. The terminal ends 144, 146 may be configured to couple with the power source 120 (FIG. 1). Characteristics of the conductive wire (e.g., wire gage) and the number of windings 142 may depend on such factors such as the degree of force required to move the plunger 106 against the fluid 104 (FIG. 1) in the pumping device 100 (FIG. 1).

The first set of windings 142 may generate the first magnetic field 114 in response to the electrical signal from the power source 120 (FIG. 1). In one example, the first set of windings 142 may operate according to the principles of Ampere's Law and/or the “right hand rule.” These principles consider that current flowing between the terminal ends 144, 146 will induce the magnetic fields 114, 116. In one implementation, current flowing from the first terminal end 144 to the second terminal end 146 may induce the first magnetic field 114 in a first field direction, as indicated by arrow M1. Under the same principles, the configuration may direct current from the second terminal end 146 to the first terminal end 144 to change the direction of the first magnetic field 114 from the first field direction M1 to a second field direction, as indicated by arrow M2.

The material member 138 may comprise a first material that exhibits magnetic properties to generate the second magnetic field 116. The first material may be ferromagnetic or otherwise configured as a permanent magnet so that the second magnetic field 116 has a constant value and constant direction, as indicated by arrow M3. In one example, the shaft member 128 may be comprised substantially of this first material. The magnetic pieces 140 may assume geometry that facilitates reciprocating movement of the plunger 106. This geometry may embody annular rings or disk, although this disclosure does contemplate other geometry (e.g., elongated strips, squares, rectangles, etc.) that might be useful for operation of the pumping device 100 in certain applications. It may be advantageous, for example, to embed or otherwise incorporate axial strips of ferromagnetic material over at least part of the length of the shaft member 128.

The fields 114, 116 may move relative to one another to generate reciprocating movement of the plunger 106. In the example of FIG. 2, such relative movement may occur because the first conductive body 136 may be held stationary relative to the magnetic pieces 140 disposed in and/or on the plunger 106. The controller 122 (FIG. 1) may regulate movement of the plunger 106 by regulating the electrical signal from the power source 120 (FIG. 1) across the first conductive body 136. The electrical signal may exhibit certain properties (e.g., direction, duration, magnitude, etc.) that determine the direction of the magnetic fields 114, 116. In one implementation, the controller 122 (FIG. 1) may be configured to vary these properties to regulate movement of the plunger 106. As noted above, the controller 122 (FIG. 1) may apply the electrical signal to the terminal ends 144, 146 in different ways to induce the different directions M1, M2 of the field 114. In some implementations, the controller 122 (FIG. 1) may modulate the electrical signal according to one or more patterned voltage polarities. These patterned voltage polarities may include a first pattern and a second pattern, one each that may induce the field 114 in the different directions M1, M2 and/or to energize the windings 142 in a way that manages the way the field 114 arises longitudinally along the axis 133. In turn, the material member 138 may be configured so that the second magnetic field 116 interacts with the first magnetic field 114 to drive the plunger 106 between the first position and the second position to generate the pumping action of the pumping device 100.

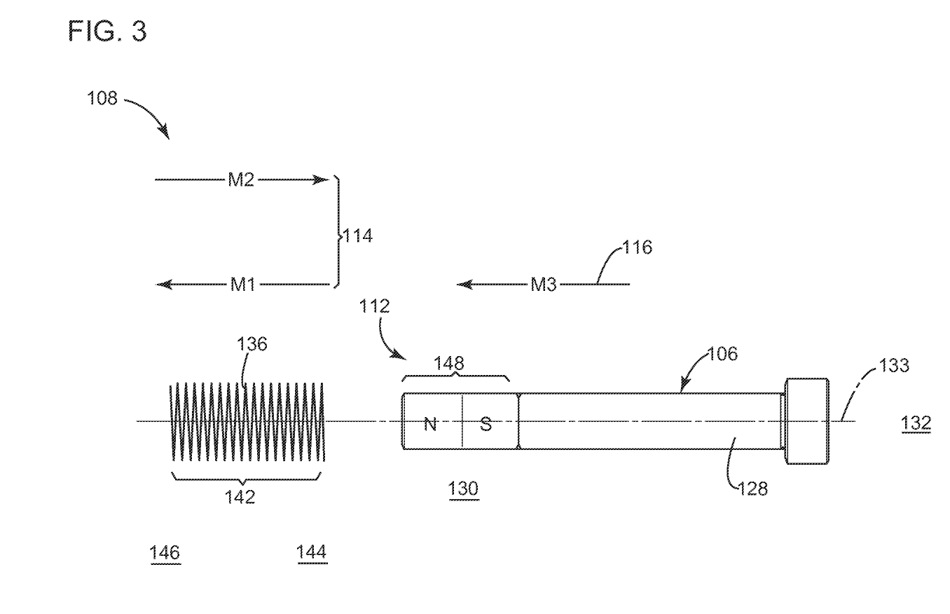

FIG. 3 depicts a schematic diagram of a plan view for a second configuration of the drive system 108. In this example, the second field generator 112 embodies one or more magnets (e.g., a first magnet 148) disposed at the first end 130 of the shaft member 128. The first magnet 148 may effectively induce (and/or provide) the second magnetic field 116 at a constant value and constant direction M3. Examples of the first magnet 148 may comprise one or more permanent magnets and materials that may create persistent magnetic field(s) in lieu of stimulation, e.g., from the electrical signal from the power source 120 (FIG. 1). This material may secure to the shaft member 128 using fasteners (e.g., adhesive) and/or integrate onto the first end 130 of the shaft member 128 as a single, monolithic unit.

The fields 114, 116 may move relative to one another to generate reciprocating movement of the plunger 106. In the example of FIG. 3, this relative movement may occur because the first conductive body 136 may be held stationary relative to the first magnetic pieces 148 that is disposed on the plunger 106. The end 130 of the plunger 106 may remain in proximity to the windings 142 to maintain interaction between the fields 114, 116. This configuration may avoid the need for the drive system 108 to require any force generator (e.g., a spring or like resilient member) that may be useful to return the plunger 106 to a set or fixed position after actuation. As noted above, the controller 122 (FIG. 1) may regulate the flow of current across the windings 142, which may function to vary the polarity of the first conductive body 136. The variations in polarity may correspond with the direction of the first magnetic field 114 as between, e.g., the first direction M1 and the second direction M2. In operation, when the direction of the first magnetic field 114 is the same as the direction of the second magnetic field 116, the first magnet 148 will repel away from the first conductive body 136. On the other hand, when the direction of the first magnetic field 114 is different from the direction of the second magnetic field 116, the first magnet 148 will attract to the first conductive body 136. Controlling the magnitude and polarity of the first magnetic field 114 may generate forces necessary to cause the motion 118 (FIG. 1) of the plunger 106 to move fluid 104 (FIG. 1) through the pump head 102 (FIG. 1).

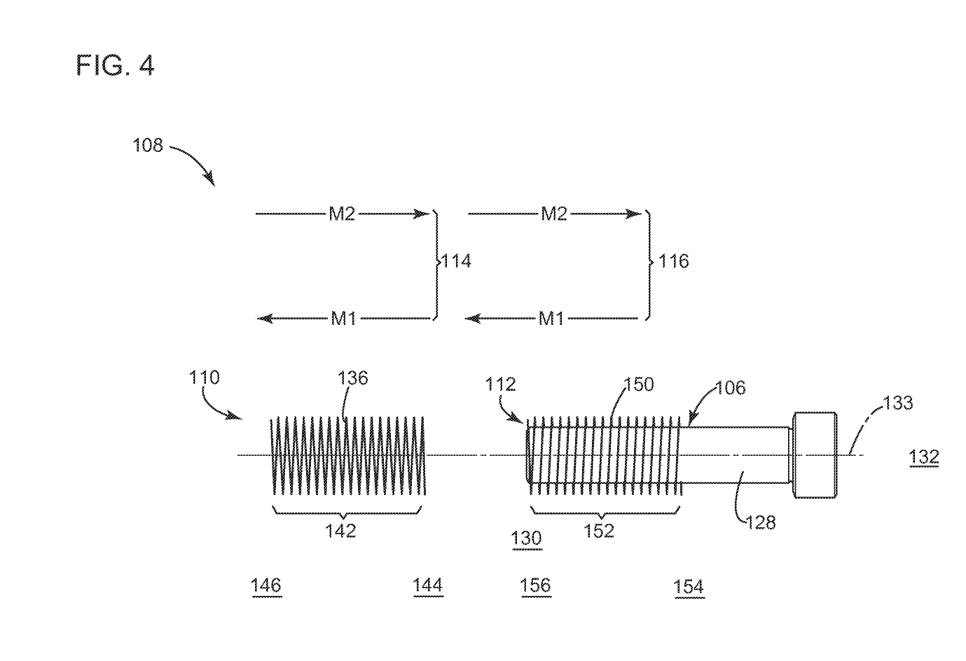

FIG. 4 depicts a schematic diagram for a third configuration of the drive system 108. The second field generator 112 has a second conductive body 150 that is configured to generate the second magnetic field 116. The second conductive body 150 may embody a coil of wound, conductive wire (or like material) forming a second set of windings 152. The windings 152 may have a pair of terminal ends (e.g., a third terminal end 154 and a fourth terminal end 156). In one example, the windings 152 of the second conductive body 150 are sized to slide over the shaft member 128. The windings 152 may be affixed in place on the shaft member 128 using fasteners, welds, adhesives, and like fastening techniques. In one example, the windings 152 reside near and/or proximate the end 130 of the shaft member 128.

In the example of FIG. 3, relative movement may occur because the windings 142 may be held stationary relative to the windings 150 that are disposed on the plunger 106. The controller 122 (FIG. 1) may regulate the electrical signal from the power source 120 (FIG. 1) to each of the windings 142, 152. Such operation will control the direction M1, M2 of the fields 114, 116. When the first magnetic field 114 and the second magnetic field 116 are in the same direction, the windings 152 are repelled away from the windings 142. This action may cause the plunger 106 to move from the first position to the second position. Changing the direction of one of the magnetic fields 114, 116 will attract the windings 142, 152 to one another, thus causing the plunger 106 to move from the second position to the first position.

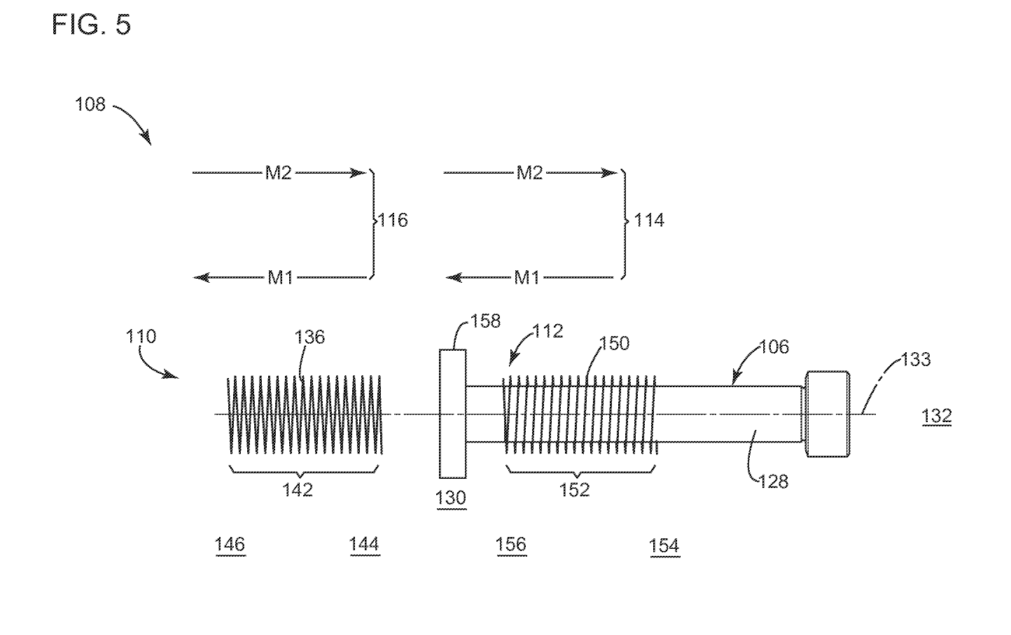

FIG. 5 depicts a schematic diagram for a fourth configuration of the drive system 108. This fourth configuration also uses a pair of conductive windings (e.g., the first set of windings 142 and the second set of windings 152). The shaft member 128 includes a disk member 158 disposed at the first end 130. The disk member 158 may reside, or is interposed, between the windings 142, 152. Examples of the disk member 158 may be configured to attract to and/or repulse from the windings 142, 152. Reciprocating motion 118 (FIG. 1) in the example of FIG. 5 may result from changes in the direction of one or more of the magnetic fields 114, 116 due to modulation of the electrical signal from the power source 120 (FIG. 1) and/or polarity of the windings 142, 152 as discussed herein.

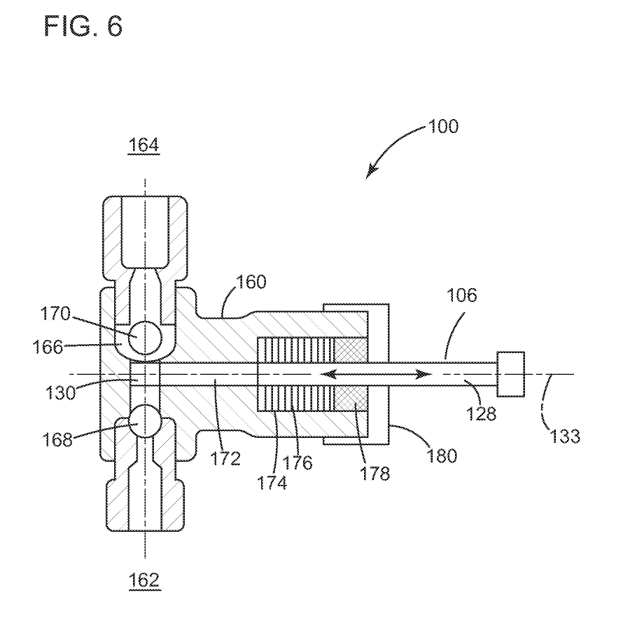

FIG. 6 depicts a schematic diagram of a section view of an example of the pumping device 100 that may incorporate the various configurations of the drive system 108 noted in FIGS. 1, 2, 3, 4, and 5 above. This example includes a body 160 with one or more inlet/outlets (e.g., a first inlet/outlet 162 and a second inlet/outlet 164). The body 160 may form an internal chamber 166 that defines a known or calibrated volume. The inlet/outlets 162, 164 may include a threaded fitting, often configured to rotatably secure and seal to the body 160. Examples of the threaded fitting may have one or more internal seals (e.g., a first internal seal 168 and a second internal seal 170). The internal seals 168, 170 may embody spring-loaded ball check valves, although this disclosure contemplates a wide variety of fluid regulating devices for use on the pumping device 100 that may be configured to isolate the fluid 104 (FIG. 1) in the internal chamber 166.

The body 160 may include one or more bores (e.g., a first bore 172 and a second bore 174). The first bore 172 may have open ends (e.g., a first open end and a second open end). At the first open end, the first bore 172 may couple with the internal chamber 166. The second open end of the first bore 172 may be configured to allow ingress and egress of the plunger 106. In one example, the first end 130 of the shaft member 128 may insert into the first bore 172 to reside proximate the internal chamber 166 in the first position.

As also shown in FIG. 6, the second bore 174 may be coaxial with the first bore 172. This configuration defines a diameter for the second bore 174 that is larger than the diameter of the first bore 172, forming a counter-bore. In one example, the pumping device 100 may include bearings, bushings, and other components that are arranged to ensure that the plunger 106 remains sealed while in motion relative to the body 160. These components may include a plunger packing member 176 and a gland member 178, each disposed within the second bore 174 and secured in position in the body 160 by a gland nut 180.

Parts of the pumping device 100 may be formed of any suitable material that satisfies the design requirements of the particular fluid pumping application. It may be preferred that these materials are corrosion resistant to extend lifetime of parts in service. In one example, one or more of the body 160, the internal seals 168, 170, the gland member 178, and gland nut 180 may be formed of material(s) that are able to withstand high fluid pressure. Suitable materials may comprise stainless steel. Exemplary materials for the plunger packing member 176 may include nitrile rubber (Buna-N), fluoropolymer elastomer synthetic rubber (e.g., Viton), or polytetrafluoroethylene (e.g., Teflon).

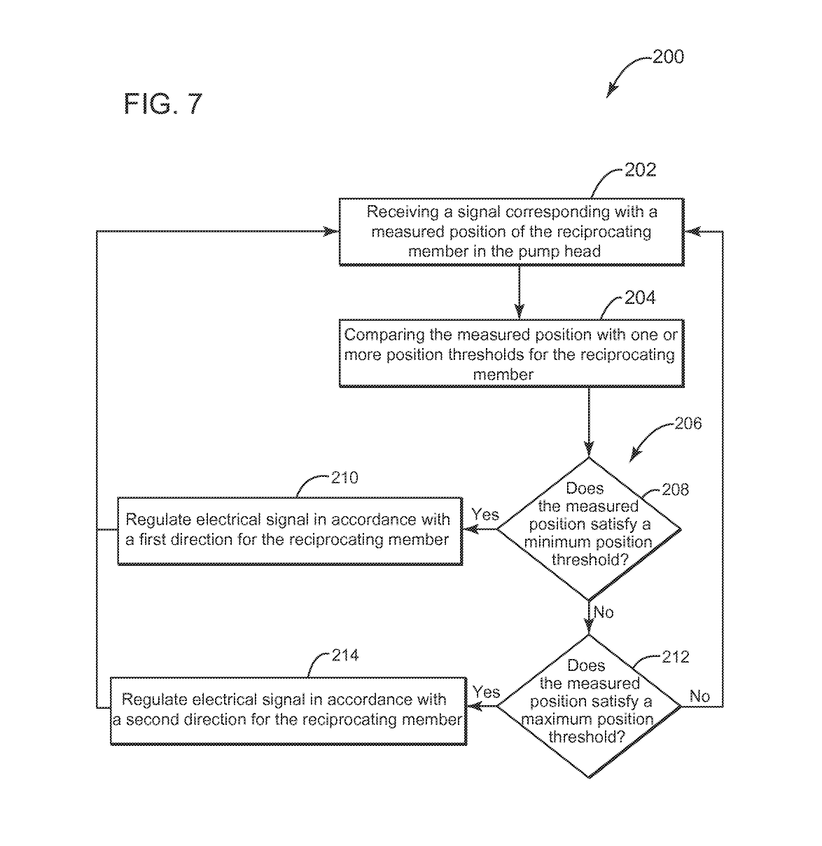

During operation, the plunger 106 may reciprocate between positions in the bores 172, 174 to change the volume of the internal chamber 166. These positions may include the first position and the second position, one each corresponding to a first volume and a second volume for the internal chamber 166. In one implementation, the plunger 106 may translate in a first direction from the first position to the second position (effectively moving from left to right in FIG. 7). This change in position draws fluid 104 (FIG. 1) into the body 160 through the first inlet/outlet 162 (also, “suction inlet/outlet 162”). The flow of fluid 104 (FIG. 1) may open the first internal seal 168 and close the second internal seal 170 at the second inlet/outlet 164 (also “discharge inlet/outlet 164”). In one example, the second position corresponds with the maximum travel or displacement of the plunger 106 away from and relative to the internal chamber 166. This maximum displacement may, in turn, cause fluid 104 (FIG. 1) to fully (or substantially) fill the volume of the internal chamber 166.

The drive system 108 may cause the plunger 106 to travel in piston-like motion back into the body 160 to evacuate the volume of the internal chamber 166. In one implementation, the plunger 106 may reverse direction to move in a second direction to translate from the second position to the first position (effectively moving from right to left in FIG. 6). This movement may increase pressure of fluid 104 (FIG. 1) in the internal chamber 166. In response to the increased pressure, the second internal seal 170 may open and the first internal seal 168 may close to allow fluid 104 (FIG. 1) to evacuate the internal chamber 166. Continued movement of the plunger 106 in the second direction pushes the fluid 104 (FIG. 1) in the internal chamber 166 through the discharge inlet/outlet 164. In use, the flow rate of fluid 104 (FIG. 1) through the pumping device 100 may correspond with the time period for the plunger 106 to complete one full cycle (e.g., translating in the first direction from the first position to the second position and, then, translating in the second direction from the second position to the first position).

FIG. 7 illustrates a flow diagram of an exemplary embodiment of a method 200 for operating a pumping device. The stages of the method 200 may be coded as one or more executable instructions, which may be stored on storage memory and/or accessible by processor(s). As noted above, the controller 122 (FIG. 1) may be configured to execute these executable instructions to regulate one or more of the magnetic fields 114, 116 (FIG. 1) to effectuate the reciprocating motion 118 (FIG. 1) of the plunger 106 (FIG. 1). The stages in method 200 may be altered, combined, omitted, and/or rearranged in some embodiments.

Some embodiments of the method 200 may include, at stage 202, receiving a signal corresponding with a measured position for a reciprocating member in the pumping device. The method 200 may also include, at stage 204, comparing the measured position to one or more position thresholds for the reciprocating member (e.g., first position threshold and a second position threshold). These position thresholds may correspond with the maximum travel and the minimum travel assigned for the reciprocating member to travel in the pump head. The position thresholds could relate to the maximum volume and the minimum volume of the internal chamber in the pump head. In one embodiment, the method 200 may include, at stage 206, determining a direction of travel for the reciprocating member in accordance with a relationship between the measured position and the one or more position thresholds. In one example, the method 200 may include, at stage 208, determining whether the measured position satisfies a minimum position threshold. If the reciprocating member is at and/or proximate the minimum allowable position, the method 200 may include, at stage 210, regulating the electrical signal in accordance with a first direction for the reciprocating member. The method 200 may return to stage 202 and repeat the method as described herein. On the other hand, if the reciprocating member is not at and/or proximate the minimum allowable position, the method 200 may include, at stage 212, determining whether the measured position satisfies a maximum position threshold. If the reciprocating member is at and/or proximate the maximum allowable position, then the method 200 may include, at stage 214, regulating the electrical signal in accordance with a second direction for the reciprocating member, wherein the second direction is different from the first direction. The method 200 may return to stage 202 and repeat the method as described herein. In one example, the method 200 may also include one or more stages (e.g., occurring after and/or contemporaneous with stage 214 in FIG. 7) for coupling the electrical signal to one of the field generators, e.g., with one or more of the first coil and the second coil discussed herein.

Embodiments of the method 200 may be implemented on any device where relevant data is present and/or otherwise accessible. Embodiments can be implemented as executable instructions (e.g., firmware, hardware, software, etc.). The controller 122 (FIG. 1) can transmit any output that results from some embodiments to a control system, asset and/or process management system, and/or independent monitoring computing device (e.g., a desktop computer, laptop computer, tablet, smartphone, mobile device, etc.). In another embodiment, the embodiments can obtain data from a historian (e.g., a repository, memory, etc.), and send data and/or outputs to an independent diagnostic computing device. The historian can be conventionally connected to control system or the asset and/or process management system. The diagnostic computing device can have all the capabilities of the monitoring computer and, in one example, the additional capability to execute executable instructions for the embodiment to process any given data. In some embodiment, the controller 122 (FIG. 1) can be configured to exchange data by wires or wirelessly, as well as through peripheral and complimentary channels.

In light of the foregoing discussion, the disclosed subject matter may be used in lieu of mechanical couplings that translate rotary motion of an electrical motor shaft into linear motion of the plunger. In some designs, configurations of the direct drive proposed herein eliminate the cross-head housing as well as the cams, gears, and other components that might introduce losses into the pumping device. In turn, use of the direct drive may reduce mechanical losses, decrease the pump unit cost, and increase flow rate accuracy.

Moreover, one or more of the stages of the methods can be coded as one or more executable instructions (e.g., hardware, firmware, software, software programs, etc.). These executable instructions can be part of a computer-implemented method and/or program, which can be executed by a processor and/or processing device. The processor may be configured to execute these executable instructions, as well as to process inputs and to generate outputs, as set forth herein. For example, the software can run on the controller 122 (FIG. 1) and/or as software, application(s), or other aggregation of executable instructions on a separate computer, tablet, laptop, smart phone, wearable device, and like computing device. These devices may generate and, in one example, display a user interface (also, a “graphical user interface”) that allows an end user to interact with the software to view and input information and data.

Computing components can embody hardware (e.g., processor and storage memory) that incorporates with other hardware (e.g., circuitry) to form a unitary and/or monolithic unit devised to execute computer programs and/or executable instructions (e.g., in the form of firmware and software). Exemplary circuits of this type may include discrete elements such as resistors, transistors, diodes, switches, and capacitors. Examples of a processor include microprocessors and other logic devices such as field programmable gate arrays (“FPGAs”) and application specific integrated circuits (“ASICs”). Storage memory can include volatile and non-volatile memory and can store executable instructions in the form of and/or including software (or firmware) instructions and configuration settings. Although all of the discrete elements, circuits, and devices function individually in a manner that is generally understood by those artisans that have ordinary skill in the electrical arts, it is their combination and integration into functional electrical groups and circuits that generally provide for the concepts that are disclosed and described herein.

Aspects of the disclosed subject matter may be embodied as a system, method, or computer program product. Some embodiments may take the form of an entirely hardware embodiment, an entirely software embodiment (including firmware, software, etc.), or an embodiment combining software and hardware aspects that may all generally be referred to herein as a “circuit,” “module” or “system.” Computer program products may embody one or more non-transitory computer readable medium(s) having computer readable program code embodied thereon.

Computer program code for carrying out operations for aspects of the present invention may be written in any combination of one or more programming languages, including an object oriented programming language and conventional procedural programming languages. Program code embodied on a computer readable medium may be transmitted using any appropriate medium, including but not limited to wireless, wireline, optical fiber cable, RF, etc., or any suitable combination of the foregoing.

As used herein, an element or function recited in the singular and proceeded with the word “a” or “an” should be understood as not excluding plural said elements or functions, unless such exclusion is explicitly recited. Furthermore, references to “one embodiment” should not be interpreted as excluding the existence of additional embodiments that also incorporate the recited features.

This written description uses examples to disclose the embodiments, including the best mode, and also to enable any person skilled in the art to practice the embodiments, including making and using any devices or systems and performing any incorporated methods. The patentable scope of the embodiments is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A pumping device, comprising:
a body forming an internal chamber;
a reciprocating member disposed in the body, the reciprocating member having a first end, a second end, and an axis; and
a drive system magnetically coupled with the reciprocating member, the drive system comprising a first conductive body affixed relative to the reciprocating member,
wherein the drive system is configured to induce a first magnetic field by energizing the first conductive body, and
wherein the reciprocating member is configured to induce a second magnetic field in a manner that causes the reciprocating member to move between a first position and a second position to fill and evacuate the internal chamber with a fluid.

2. The pumping device of claim 1, wherein the drive system comprises a second conductive body, and wherein the second magnetic field results from energizing the second conductive body.

3. The pumping device of claim 2, wherein the second conductive body is affixed to the reciprocating member.

4. The pumping device of claim 1, wherein the first conductive body is disposed coaxially with the axis of the reciprocating member, and wherein the reciprocating member is configured to translate through the first conductive body between the first position and the second position.

5. The pumping device of claim 1, further comprising a plurality of shaft members coupled to the reciprocating member and spaced apart from one another along the axis, wherein the shaft members are configured to generate the second magnetic field at a value and a direction that are constant.

6. The pumping device of claim 5, wherein the first magnetic field corresponds with a first pattern and a second pattern of voltage polarities that energize the first conductive body, and wherein the first pattern and the second pattern are configured so that the reciprocating member moves from the first position to the second position in response to the first pattern and from the second position to the first position in response to the second pattern.

7. The pumping device of claim 1, wherein the drive system comprises a magnet disposed on the first end of the reciprocating member, and wherein the magnet generates the second magnetic field at a value and a direction that are constant.

8. The pumping device of claim 1, further comprising a control system comprising:
a sensor system proximate the reciprocating member; and
a controller coupled with the sensor system,
wherein the controller is configured to modulate the first magnetic field and the second magnetic field in response to a signal from the sensor system that corresponds with one of the first position and the second position of the reciprocating member.

9. The pumping device of claim 8, wherein the sensor system comprises a pair of sensors in position relative to the reciprocating member, and wherein the pair of sensors are configured to generate a first signal and a second signal, one each that indicates the first position and the second position.

10. The pumping device of claim 8, wherein the controller has a processor with access to executable instructions, and wherein the processor is configured to execute the executable instruction to configure the controller to,
receive the signal from the sensor system, the signal corresponding with a measured position for the reciprocating member in the body;
compare the measured position to one or more position thresholds for the reciprocating member;
determine a direction of travel for the reciprocating member in accordance with a relationship between the measured position and the one or more position thresholds; and
regulate an electrical signal to induce one or more of the first magnetic field and the second magnetic field corresponding with the direction of travel for the reciprocating member.

11. A pumping device, comprising:
a body comprising a first inlet/outlet, a second inlet/outlet, and an internal chamber in flow communication with each of the first inlet/outlet and the second inlet/outlet, the body having a first bore coupled with the internal chamber;
a reciprocating member disposed in the first bore, the reciprocating member having a first end, a second end, and an axis;
a first coil affixed in the body, the first coil comprising a first set of windings that circumscribe the axis of the reciprocating member,
wherein the first set of windings are configured to generate a first magnetic field in response to an electrical signal, and
wherein the reciprocating member is configured to generate a second magnetic field to move the reciprocating member between a first position and a second position in the first bore in response to an interaction with the first magnetic field.

12. The pumping device of claim 11, further comprising a magnet coupled to the reciprocating member, wherein the magnet generates the second magnetic field at a constant value and in a constant direction.

13. The pumping device of claim 12, wherein the reciprocating member is configured to move at least partially through the first set of windings.

14. The pumping device of claim 11, further comprising a second coil spaced apart from the first coil along the axis, the second coil comprising a second set of windings that are configured to generate the second magnetic field.

15. The pumping device of claim 14, wherein the second set of windings is affixed to the reciprocating member.

16. The pumping device of claim 11, further comprising
a first sensor in proximity to the reciprocating member; and
a controller coupled with the first sensor, the controller configured to modulate an electrical signal to induce at least one of the first magnetic field and the second magnetic field.

17. The pumping device of claim 16, wherein the controller has a processor with access to executable instructions, and wherein the processor is configured to execute the executable instruction to configure the controller to,
receive a signal from the first sensor, the signal corresponding with a measured position for a reciprocating member in the pumping device;
compare the measured position to one or more position thresholds for the reciprocating member;
determine a direction of travel for the reciprocating member in accordance with a relationship between the measured position and the one or more position thresholds; and
regulate the electrical signal to induce one or more of the first magnetic field and the second magnetic field corresponding with the direction of travel for the reciprocating member.

18. A method of operating a pumping device, comprising:
at a controller comprising a processor configured to execute executable instructions for:
receiving a signal corresponding with a measured position for a reciprocating member in the pumping device;
comparing the measured position to one or more position thresholds for the reciprocating member;
determining a direction of travel for the reciprocating member in accordance with a relationship between the measured position and the one or more position thresholds; and
regulating an electrical signal to induce one or more magnetic fields corresponding with the direction of travel for the reciprocating member.

19. The method of claim 18, further comprising:
coupling the electrical signal to a first coil magnetically coupled with the reciprocating member, wherein the first coil is configured to generate a first magnetic field that corresponds with the direction of travel for the reciprocating member.

20. The method of claim 19, further comprising:
coupling the electrical signal to a second coil that is spaced part from and magnetically coupled with the first coil, wherein the second coil is configured to generate a second magnetic field that corresponds with the direction of travel for the reciprocating member.
